(19) United States
(12) Patent Application Publication
(10) Pub. No.: US 2007/0107746 A1
(43) Pub. Date: May 17, 2007

(54) 3-N-1 braid mending hot scissors

(76) Inventor: Mary Jean Randolph, Palm Desert, CA (US)

Correspondence Address: Mary Jean Randolph, 72600 Fred Waring Drive, #3206, Palm Desert, CA, 92260, US

(21) Appl. No.: 11/450,199

(22) Filed: Jun. 9, 2006

Related U.S. Application Data
(60) Provisional application No. 60/731,649, filed on Oct. 27, 2005.

(51) Int. Cl. B23D 21/06; A45D 24/10; A45D 1/04; A45D 26/00

(52) U.S. Cl. 132/118; 132/232; 30/104; 219/223

(57) ABSTRACT

The 3-N-1 BRAID MENDING HOT SCISSORS have a specially design handle configure to fit all the member.
1). The Power Source Handle
2). The Braid Mending Hot Scissors
3). The Steam Braider
4). The Weave Comb
5). The 3-N-1 Holder

Each Members 2) 3) 4) have a heating coil socket; that connect individually inside socket slot at the end of Member 1), which is the heat resistant power Source handle that will convert into a whole unit Once plugged into an outlet the person has to set the temperature gage; this will cause heating elements to generate heat into each of the members and allow the beautician or In-house braiders to style their braids and weave in a comfortable and safe manner, after use store unit in 3-N-1 Holder.

The 3-N-1 BRAID MENDING HOT SCISSORS have a specially design handle configure to fit all the member.
1). The Power Source Handle
2). The Braid Mending Hot Scissors
3). The Steam Braider
4). The Weave Comb
5). The 3-N-1 Holder

Each Members 2) 3) 4) have a heating coil socket; that connect individually inside socket slot at the end of The Power Source handle.

The Power Source handle, which is heat resistant, will connect individually to each member and convert into a whole unit

The whole unit. Once plugged Into an outlet, can be set with a temperature gage; this will cause heating elements to generate heat into The Power Source handle.

The beautician or In-house braiders can style their braids andlor weave in a comfortable and safe manner, being able to select which member they need. (Members 2, 3 and 4)

After use store each member (members 2, 3, 4) in the 3-N-1 Holder.

Application and use of the 3-N-1 Braid Mending Hot Scissors (Eliminating Lighters and Hot Water) Suitable for Beauticians and Braiders

This product could be utilized to seal and curl the ends of any synthetic extension or braid, after extensions are applied or periodically to trim and reseal and re-curl the braids.

Plugging the standard power outlet, the user would activate the unit setting the device to the desired temperature, thus causing the heating, elements to rise and heating the cutting blades. Grasping the heat resistant handle, the user would gently squeeze the upper and lower handle grip together, thus opening the scissors blades the user would then simply clamp the device over the ends of the extension, holding the unit in place for several seconds in order to trim the ends, while simultaneously heating and sealing the end of the braids. At which point the user would simply unplug the unit letting the blades cool off. The user would switch the end of the unit (Scissors) and attached the Steam Braider to the power cord handle; pour water in the tube once unit is hot, and simply curl your braid with the steam braiders eliminating the need to soak the extension in hot water. A process which can often render the wear of the extensions and the hassle of dripping wet braids. Unplug the unit (Steam Braiders) and attach Weave Comb to the power cord handle. The weave comb will allow you to keep your weave straight and silky. It will eliminate the frizz and tangles that weave develop. This invention would allow those who wear extension and weaves to care for the tips in a manner that is comfortable and safe; after completion you would simply unplug the unit, detach anyone of the three heads from the unit and safely store the 3-N-1 set in the Holder.

### BACKGROUND OF THE INVENTION

Throughout history, men and women alike have modified and arranged their hair as means of improving appearance, designating class and celebrating religion. Today, although the social religious and political implications of styling the hair has vastly changed, grooming the hair as a means of self expression and self improvement is still in practice.

One particularly popular way many choose to style their hair is by applying a hair weave. A hair weave Is a process through which natural or synthetic hair strands are bonded to a person's existing hair, typically at the root of hair shaft, directly above the scalp. This process is especially popular among African American men and women, offering these consumers a simple way in which to sport long straight or braided hairstyles without the hassle associated with growing out thick, texture hair or repeatedly visiting the salon for a perm.

When applying a weave to the hair, professional stylists can utilize glues or waxes to secure the new hair in place. Once the weave or braided extension has been secured to the existing hair, the ends of each extension are typically dipped in hot water or burned with a lighter or match in order to seal the tips of the hair thus preventing the end from fraying and ensuring a neat and uniform look. Unfortunately, sealing the ends of the braid in this manner is not without drawbacks.

For those who choose to seal or curl their braids with hot water, doing so typically results in hot water dripping on one's clothing and garments, For those who utilize lighter or matches to seal their hair, the challenges associated with this task can be even more problematic, Simply stated, repeatedly sparking a lighter in order to seal dozens of braided extensions can result in sore and blistered thumbs. In addition the act of holding a lighter or match to the end of the hair can often result in painful and in some cases serious, burns to the fingers and hands.

Another problem associated with sealing the ends of braids is that over time. These extensions can unravel, requiring the user to reseal and in most cases, trim the ends. And the weave becomes dry and tangled The subject of this report Is the 3-N-1 Braid Mending Hot Scissors, Weave Comb and Steam Braiders a unique product invention which would offer consumer a practical solution to aforementioned problems.

### SUMMARY OF THE INVENTION

3-N-1 Braid mending hot Scissors that contain stainless steel scissors blades; that mend the tips of the synthetic braids with a design cut or a straight cut. CERAMIC STEAM BRAIDER with spikes attached to the upper flip handle to grip the braids, holes that produce steam to curl the braids when you pour water in tube. Also CERAMIC WEAVE STEAM COMB to straighten a hair weaves. The entire product Scissors, Steam braider Weave Comb connect individually to the same Heat Resistant Handle with looped thumb and finger grip, Indicator lamp, heat adjustment gage box and power cord, and release button to change the MEMBERS Scissors, Steam braider, Weave comb Also A 3-N-1 Holder; that contains slots-holes and hooks to store or hang other accessories; their will be various sizes, shapes and colors. And the measurements . . . Heights or Lengths +/− Various, Width +/− Various and Dept +/− Various Also Material needed various.

Application and use of the 3-N-1 BRAID MENDING HOT SCISSORS would be very simple and straight forward. (Eliminating Lighters and Hot Water) suitable for Beautician and In-house Braiders, The 3-N-1 products could be utilized to seal and curl and straighten the ends of any synthetic extension or braid. After extension are applied or periodically to trim and reseal and re-curl the braids. Plugging the standard power cord into outlet, the user would activate the unit setting the device to desired temperature, thus causing the heating, elements to rise and heating the cutting blades. Grasping the heat resistant looped thumb and finger grip handle the user would gently squeeze the upper and lower handle grip together, thus opening the scissors blades the user would then simply clamp the device over the ends of the extension, holding the unit in place for several seconds in order to trim the ends while simultaneously heating and sealing the end of the braids. At which point the user would simply turn off the switch on the gage box unplug the unit and press the release button on the unit to release (Scissors) and attached the steam braider to the heat resistant power cord handle; pour water in the tip of the tube with twist cap once unit is activated it will produce steam threw the holes then you simply take the braided extension and clamp the flip handle with spikes to grip and curl the braids with the steam, eliminating the need to soak the extension in hot water.

A process which can often render the wear of the extension and eliminated the hassle of dripping wet braids this process will give your braids a moist and curly lool Turn switch off on the gage box unplug the unit press release button to release (Steam braider) and attached weave comb to the heat resistant power cord handle and activate the unit, this will allow the weave comb to heat up then take a few strand of weaved hair and comb the weave to get a straight and silky look eliminating the frizz and tangles, that weaves develop.

This invention would allow those who wear extension and weaves to care for the tips in a manner that is comfortable and safe; after completion you would simply turn off the switch on the gage box and unplug the unit press release button and detach anyone of the three members from the power source handle and safely store in the 3-N-1 Holder.

My idea is unique and was designed for everybody who wears braids or weaves. What inspired me was my extensions would unravel at the ends. And I became frustrated and put a pair of scissors on the stove and I solved the problem; I suggested to myself that it would be a good Idea to have a pair of electric braid scissor and also that the braid mending hot scissors would also be well suited, for general household use. Durably constructed of quality material, these cleverly designed styling tools should with stand years of repeated use, with ease. The Braid Mending Hot Scissor Set would offer consumers an exciting, new addition to the hair care market. Providing a simple and convenient means of cutting, sealing and curling braids, also straightening weaves this unique styling tool could prove a favorite for women and men alike. Affordably priced the 3-N-1 Braid Mending Hot Scissors should be well received by anyone who enjoys wearing synthetic extensions and braids, a very sizeable market potential.

### DESCRIPTION OF DRAWINGS

Member 1— POWER SOURCE HANDLE FIG.-1# upper heat resistant handle with thumb looped grip FIG.-2# indicator light FIG.-3# release button FIG.-4 socket slot FIG.-5# elongated power cord FIG.-6# gage box FIG.-7# dial temperature FIG.-8# plug.

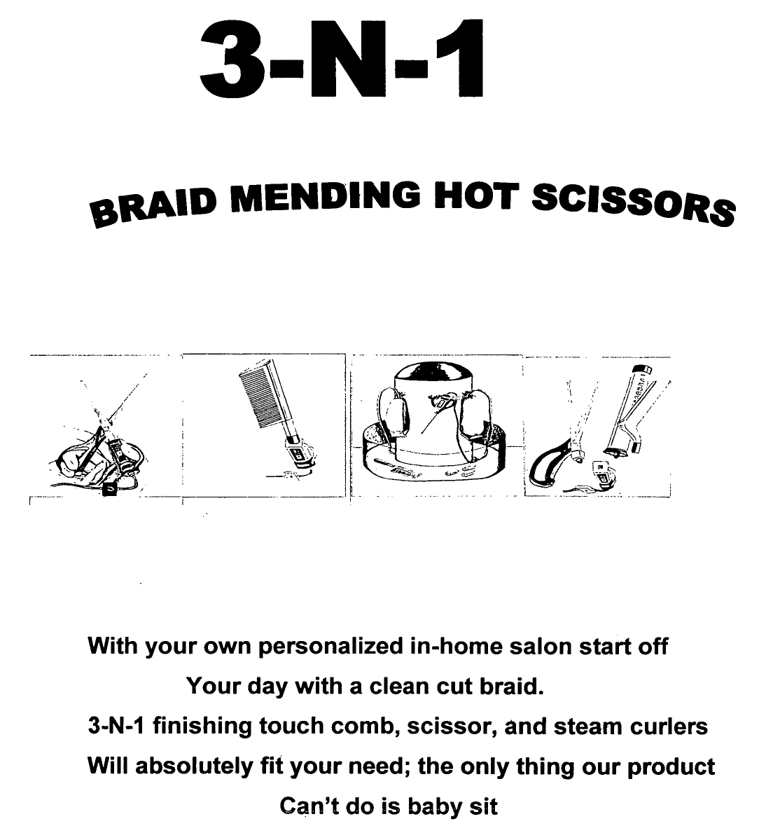

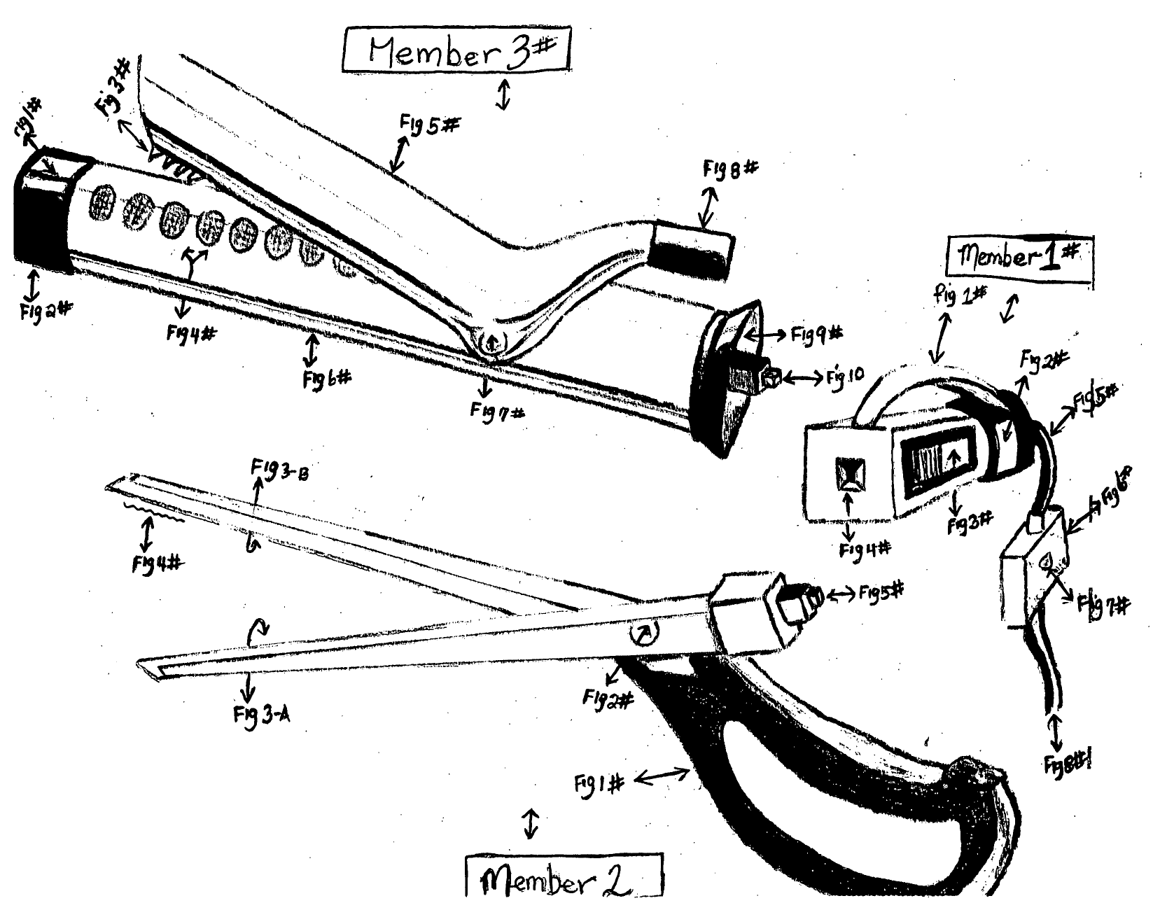

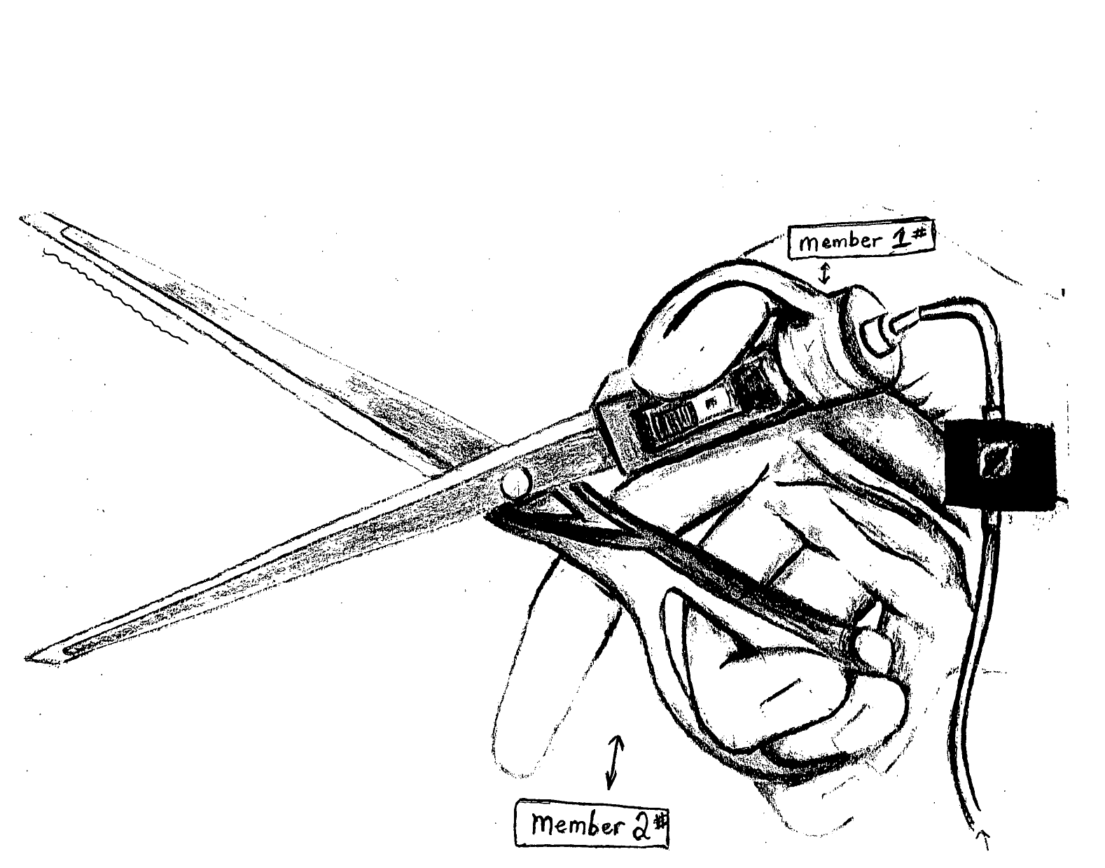

Member 2— BRAID-MENDING HOT SCISSORS FIG.-1# lower heat resistant finger grip handle FIG.-2# pivot pin FIG.-3-A# lower heated blade FIG. 3-B# upper heated blade FIG.-4# with design cut FIG.-5# socket with heating coil.

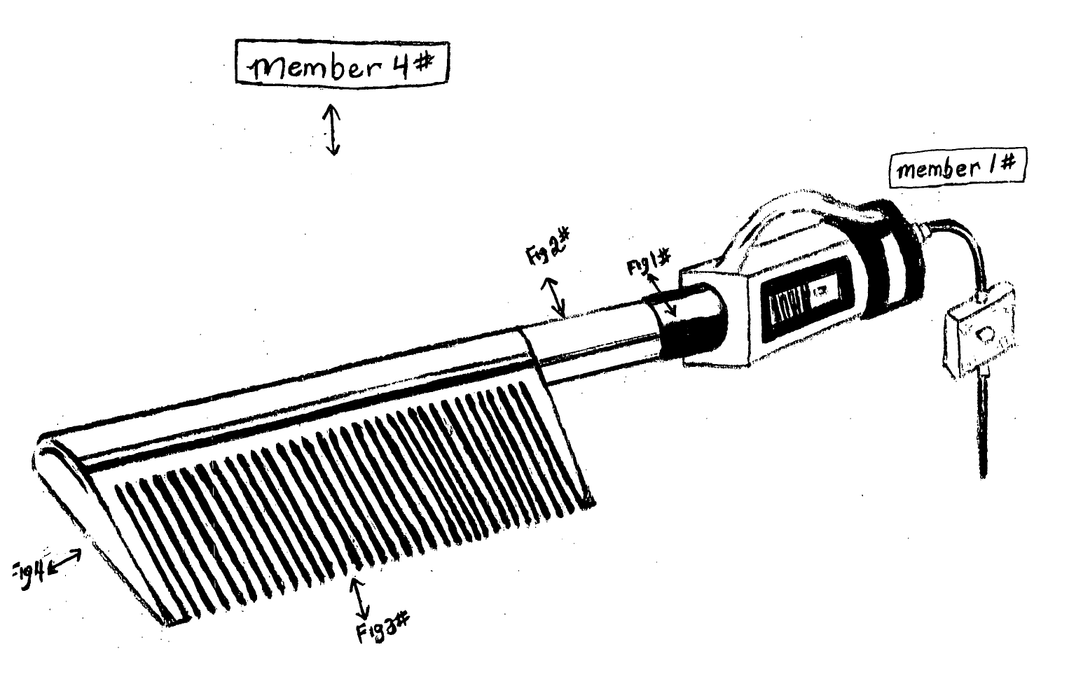

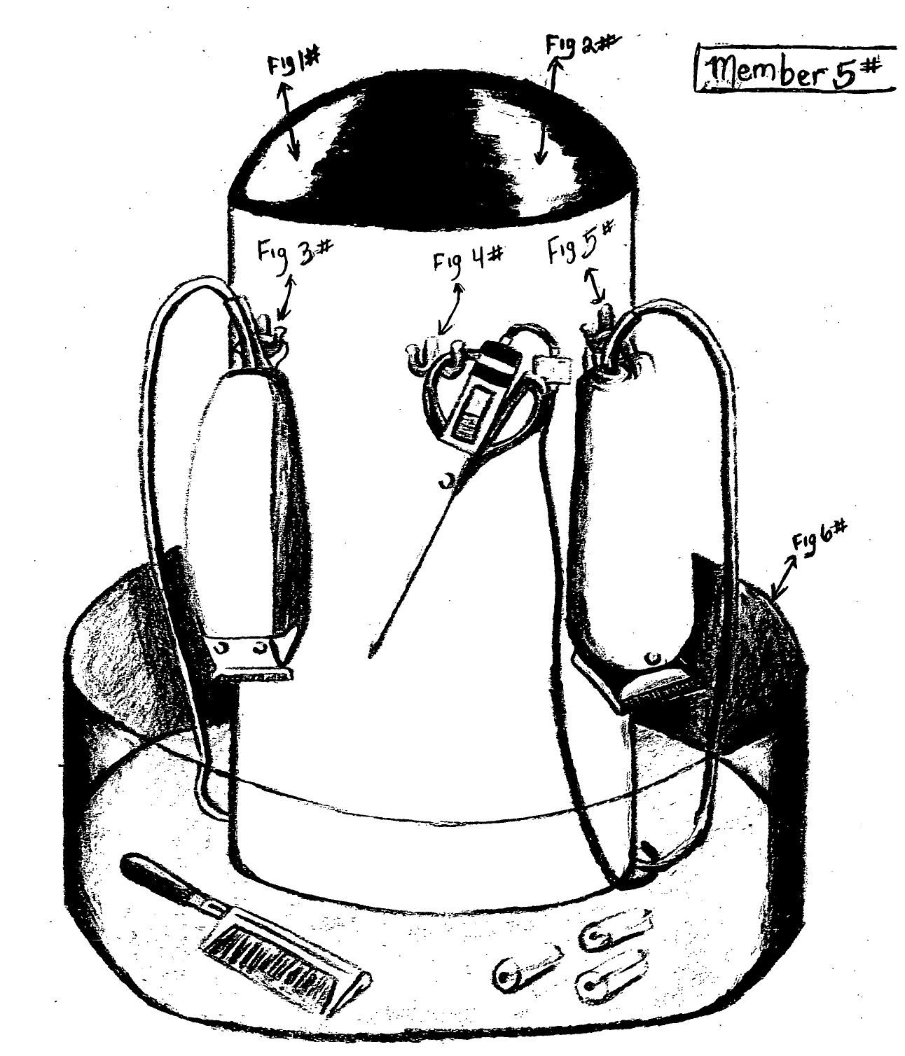

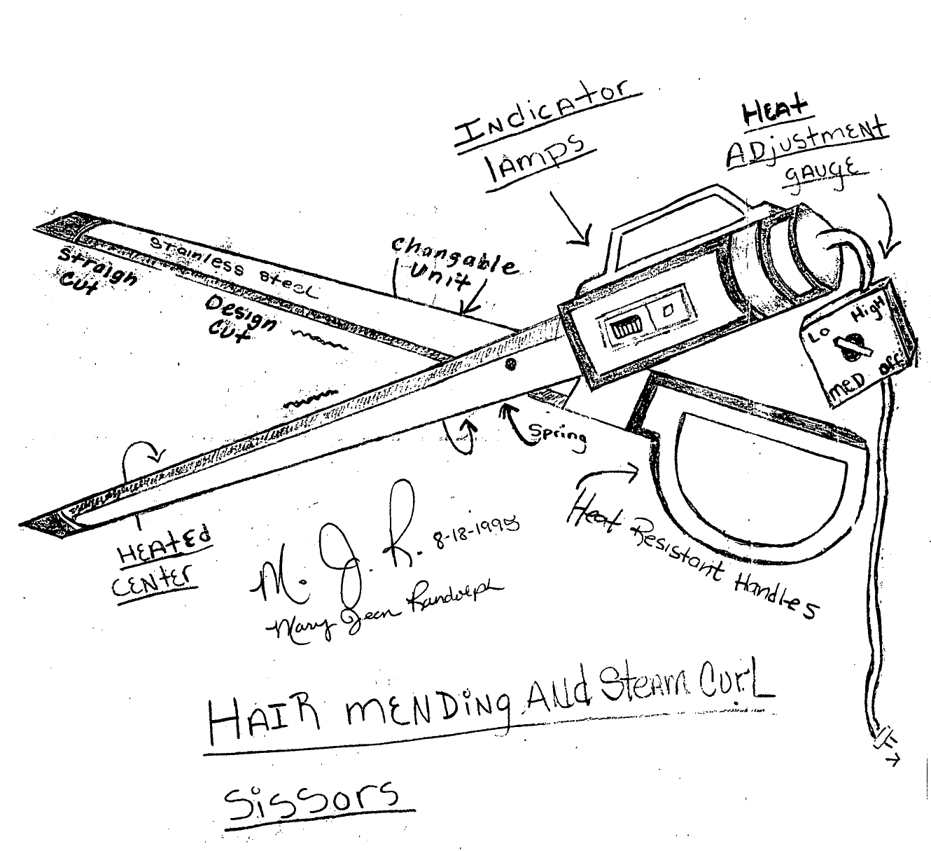

Member 3— STEAM BRAIDER FIG.-1# open slot to pour water FIG.-2# heat resistant rubber twist cap FIG.-3# spikes to grip braids FIG.-4# steam holes FIG.-5# flap handle FIG.-6# flute shaped handle FIG.-7# pivot pin FIG.-8# heat resistant rubber thumb press handle FIG. 9# inside water reservoir FIG.-10# socket with heating coil.

Member 4— WEAVE COMB FIG.-1# socket with heating coil FIG.-2# heat resistant handle FIG.-3# teeth in the comb FIG.-4# the comb.

Member 5— 3-N-1 OVAL SHAPED HOLDER FIG.-1# open slot FIG.-2# open slot FIG.-3# hook FIG.-4# hook FIG.-5# hook FIG.-6# tray.

### DETAILED DESCRIPTION OF THE PREFERRED EMBODMENT

The aforementioned needs are satisfied by the 3-N-1 Braid Mending Hot Scissors, Steam Braiders and Weave Comb have a special design handle; configured to fit all the members specially designed hair styling tools configured specifically to use in heating, cutting, sealing, curling braids and straightening weaves.

Each of the members has a socket with a heating coil at the end of the body that fits inside the slot on the base of the heat resistant power source handle. Member 1# would be the heat resistant power source handle with thumb grip and socket slot, indicator light, release button; elongated power cord with plug, temperature gage box with three temperatures setting, Member 2 is braid mending hot scissors similar to a standard pair of scissors The braid mending hot scissors would be comprised of two, elongated cutting blades, manufactured of heavy duty stainless steel or similar conductive material and joined together via a simple pivot pin.

Incorporated into each cutting blades would be an design or straight blade cut with integrated heating element, designed to heat the cutting edge of the blades in order to seal the ends of the braid over which unit is secured As with traditional scissors, the cutting blades would be opened and closed by way of an ergonomically designed, heat resistant handles, with both sides of the handle featuring a comfortable looped thumb and finger grips. Member 1# Positioned on Member 2# upper portion of the handle. would be a dial temperature gauge featuring three temperature settings. As well as an integrated indicator light this illuminated when the unit is plugged up and turned on. The Braid Mending Hot Scissors would operate on conventional 120 volts, 60 hertz power and would be connected to a standard power outlet via an elongated power cord integrally attached the base of the unit.

Member 3# would be the steam braider the steam braider is a special design braid styling tool configured specifically for curling synthetic braids the steam braider is similar to a standard pair of curling iron except at the tip of the steam braider their will be a open slot on top of twist cap to pour water inside the flute shaped handle attached to flap handle with spikes sticking out to catch the braids joined together with a via a simple pivot pin. There will be a reservoir inside the flute shaped handle where the water will remain trapped inside to produce steam to the outer surface of the steam holes once this unit is connected to Member 1# the same heat resistant handle as mentioned above the heating element from the power source will produce heating elements to the steam braider and produce steam from the holes to lock curls in the braids.

Member 4# would be the weave comb. The weave comb is a specially designed comb made out of stainless steel or similar conductive material configured specifically for straightening a weave, the weave comb Relates to a standard hair comb, this member will connect to Member 1# the same heat resistant handle as mentioned above; the heating elements from the power source wil produce heating elements to the base of the comb which will produce heating elements threw the teeth of the comb to allow the stylist to straighten a weave Member 5# the 3-N-1 holder is a oval shaped holder with a tray surface specially designed for storing the 3-N-1 braid mending hot scissors set The holder will have hole slots to store steam braider, weave comb and their will be hooks on the surface of the oval shaped holder to hang the hair mending scissors.

What I claim as my invention is:

1. 3-n-1 braid mending hot scissors that contain stainless steel scissors blades that mend the tips of the synthetic braids with a design cut or a straight cut. Ceramic Steam Braider with spikes attached to the upper flip handle to grip the braids, holes that produce steam to curl the braids when you pour water in the tube. Also Weave Comb to straighten a hair weaves. The entire product Scissors, Steam braider Weave Comb connect individually to the same Heat Resistant Handle converting them into one whole unit with looped thumb and finger grip, Indicator lamp, heat adjustment gage box and power cord and release button to change the members SCISSORS, STEAM BRAIDER WEAVE COMB and also a 3-N-1 Holder; that contain slot-holes and hooks to store or hang other accessories; their will various sizes, shapes and colors. And the measurement . . . Heights or Lengths+/−Various Width+/−Various and Dept+/−Various Also Material needed various.

2. The aforementioned needs are satisfied by the 3-N-1 Braid Mending Hot Scissors, Steam Braiders and Weave Comb have a special design handle; configured to fit all the members, specially designed braid styling tools configured specifically to use in heating, cutting, sealing, curling braids and straightening hair weaves. Each of the members has a socket with a heating coil at the end of the body that fits inside the slot on the base of the heat resistant power source handle, These Members would be the heat resistant power source handle with thumb grip and socket slot, indicator light, release button; elongated power cord with plug, temperature gage box with three temperatures setting and the braid mending hot scissors similar to a standard pair of scissors, The braid mending hot scissors would be comprised of two, elongated cutting blades, manufactured of heavy duty stainless steel or similar conductive material and joined together via a simple pivot pin. Incorporated into each cutting blades would be an design or straight blade cut with integrated heating element, designed to heat the cutting edge of the blades in order to seal the ends of the braid over which unit is secured. As with traditional scissors, the cutting blades would be opened and closed by way of an ergonomically designed, heat resistant handles with both sides of the handle featuring a comfortable looped thumb and finger grips, attach both Members braid mending hot scissor Positioned on upper portion of the power source handle will convert into a whole unit their will be a dial temperature gauge featuring three temperature settings. As well as an integrated indicator light this is illuminated when the unit Is plugged up and turned on The power source handle will allow Braid mending Hot Scissors to operate on conventional 120 volts, 60 hertz power and would be connected to a standard power outlet via an elongated power cord integrally attached at the base of the unit.

3. Another members would be the steam braider and weave comb the steam braider and weave comb is a special design braid and hair styling tool configured specifically for curling synthetic braids and straightening hair weaves the steam braider is similar to a standard pair of curling iron except at the top of the steam braider their will be a open slot on top of the twist cap to pour water inside the flute shaped handle attached to flap handle with via a simple pivot pin with spikes sticking out From under neath the flap handle to catch the braids joined together. There will be a reservoir inside the flute shaped handle where the water will remain trapped inside to produce steam to the outer surface of the steam holes once this unit is connected to the same heat resistant handle as mentioned above will convert into a whole unit the heating element from the power source will produce heating elements to the steam braider and produce steam from the hole to lock curl in the braids. The weave comb is a specially designed comb made out of stainless steel or similar conductive material configured specifically for straightening a hair weave, the weave comb relates to a standard hair comb, it will connect to the same heat resistant handle as mentioned above and will convert into a whole unit the heating elements from the power source handle will produce heating elements to the base of the comb which will produce heating elements threw the teeth to allow the stylist to straighten a hair weave the 3-N-1 braid mending hot scissor will be stored in the 3-N-1 oval shaped holder with a tray surface stand specially designed for storing steam braider, weave comb and their will be hooks on the surface of the oval shaped holder to hang the braid mending hot scissors.

4. (cancelled)

5. (cancelled)
